(19) United States
(12) Patent Application Publication
(10) Pub. No.: US 2025/0322334 A1
(43) Pub. Date: Oct. 16, 2025

(54) AI-DRIVEN ROBOTIC PROCESS AUTOMATION

(71) Applicant: INTERNATIONAL BUSINESS MACHINES CORPORATION, ARMONK, NY (US)

(72) Inventors: Hamid Majdabadi, OTTAWA (CA); Lam Fung Ng, Scarborough (CA); Steve Pham, Windsor (CA); Halim Lee, Thornhill (CA)

(21) Appl. No.: 18/633,438

(22) Filed: Apr. 11, 2024

(51) Int. Cl. G06Q 10/0631; H04L 65/403

(52) U.S. Cl. CPC G06Q 10/06316; G06Q 10/063116; G06Q 10/06312; H04L 65/403

(57) ABSTRACT

Electronic collaborative scheduling uses word data to generate a recommended schedule. A robotic process automation agent operates in the background of an electronic meeting. Data related to schedule-based topics detected by the robotic process automation agent as coming from a plurality of participants in the electronic meeting is received. The received data is forwarded to an artificial intelligence engine. The artificial intelligence engine determines a recommended schedule of workflow completion for tasks related to topics of the electronic meeting. The robotic process automation agent displays the recommended schedule.

### BACKGROUND

### Technical Field

The present disclosure generally relates to information and communication technology, and more particularly, to real-time detection and visualization recommendation of schedule-based speech insight in virtual collaboration powered by AI-driven Robotic Process Automation (RPA).

### Description of the Related Art

Virtual meetings are now the primary way of interacting among colleagues in a post-pandemic era. Often during a virtual meeting, there are schedule-based topics and dates discussed. The group is expected to come to an agreement on proposed times and deadlines. Commonly, individual members have other deadlines that may conflict with other stake holders participating in the meeting.

### SUMMARY

According to an embodiment of the present disclosure, a computer program product for electronic collaborative scheduling includes one or more computer readable storage media, and program instructions collectively stored on the one or more computer readable storage media. The program instructions include operating a robotic process automation agent in a background of an electronic meeting. Data related to schedule-based topics detected by the robotic process automation agent as coming from a plurality of participants in the electronic meeting is received. The received data is forwarded to an artificial intelligence engine. The artificial intelligence engine determines a recommended schedule of workflow completion for tasks related to topics of the electronic meeting. The robotic process automation agent displays the recommended schedule.

According to an embodiment of the present disclosure, a method for electronic collaborative scheduling includes operating a robotic process automation agent in a background of an electronic meeting. Data related to schedule-based topics detected by the robotic process automation agent as coming from a plurality of participants in the electronic meeting is received. The received data is forwarded to an artificial intelligence engine. The artificial intelligence engine determines a recommended schedule of workflow completion for tasks related to topics of the electronic meeting. The robotic process automation agent displays the recommended schedule.

According to an embodiment of the present disclosure, a computing system includes a processor operating a teleconferencing program and a robotic automation process agent running in a background of the teleconferencing program. Memory is coupled to the processor. The memory stores instructions causing the processor to perform acts comprising operating the robotic process automation agent in a background of an electronic meeting hosted by the teleconferencing program. Data related to schedule-based topics detected by the robotic process automation agent as coming from a plurality of participants in the electronic meeting is received.

The received data is forwarded to an artificial intelligence engine. The artificial intelligence engine determines a recommended schedule of workflow completion for tasks related to topics of the electronic meeting. The robotic process automation agent displays the recommended schedule.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for speech-based collaborative scheduling, consistent with an illustrative embodiment.

FIG. 2 is a block diagram of an architecture for speech-based collaborative scheduling, consistent with an illustrative embodiment.

FIGS. 3A and 3B are a flowchart of a method for speech-based collaborative scheduling, according to an embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Speech Recognition, as used herein, refers to a machine enabled function that recognizes verbal or printed words.

Teleconferencing, as used herein, refers to a software program that enables multiple individuals to meet through a telecommunications system either by telephone, video, radio, Internet Protocol, or any combination of the aforementioned.

Agent, as used herein, refers to a software application that operates as an auxiliary program to another host program.

Plug-in, as used herein, refers to a software component that adds a specific feature to an existing computer program.

Module, as used herein, refers to a software application, which may be standalone or may be a hardware component that includes the software application programmed in to memory or a circuit.

Applications integrations module, as used herein, refers to a software module that enables individual applications, each designed for its own specific purpose, to work with one another.

Robotic Process Automation (RPA), as used herein, refers to automated software application(s) that develop an action list of tasks to be performed by watching a user or other application perform a task. Sometimes that task is observed in an application's graphical user interface (GUI). The RPA then performs automation by repeating the observed tasks.

Applications Programming Interface (API), as used herein, refers to an intermediary layer of software that processes data transfers between systems using a set of defined rules that enable different applications to communicate with each other.

Artificial intelligence, as used herein, refers to computer systems, and sometimes their software, capable of performing complex tasks that historically only a human could do, such as reasoning, making decisions, or solving problems.

Intent, as used herein, refers to understanding how words that are expressed by a person relate to a person's time or availability.

Conversation, as used herein, refers to words exchanged between live participants, offline participants, and between participants and a computing device.

### Overview

The present disclosure generally relates to automated scheduling of multiple parties cooperating on a project or other set of tasks. The conventional approach is to designate one participant as a scheduler. The scheduler suggests dates and deadlines for completion of tasks or projects. Sometimes the scheduler asks each participant whether a date (or dates) fits within their schedule. It is extremely hard to keep track of all cross-reference conversations and correlate them all to different dates and counters schedules to agree on time frames and deadlines that are flexible fit everyone's individual schedules. The target participant checks their own calendar and replies, usually in the negative. Then a process of back-and-forth negotiation for a date occurs. Then the scheduler moves on to the next person and repeats the process until a schedule is generated. However, this conventional process is heavily time consuming and can take up most of a meeting. Often, the scheduling process extends a meeting beyond its projected time for completion. During the scheduling interrogation of one member, the other members are idling.

There are some calendaring systems that allow individuals to input their own respective availability. However, these are primarily manual and lack conflict checks. In addition, such systems are prone to biases in scheduling from individuals that prioritize their own time and availability over the priority of project completion.

Embodiments disclosed herein automatically detect language used in collaborative sessions that relate to schedule-based topics. Typically, when collaborators are trying to reconcile individual schedules, an arbitrary set of dates and deadlines are initially used, which are frequently revised on the fly by a meeting organizer. As information about schedules is being brought up during a meeting, the scheduler may often miss important information or may not see how new information affects other scheduled tasks. As one participant protests to a proposed date or deadline, a modification to the schedule may conflict with others' schedules. In another example, changing one person's deadline may affect timing of completion for one or more other persons' deadlines because the other parties work may be dependent on the completion of the first party's assignment. To complicate matters further, individuals may have other events that intervene between proposed dates/deadlines (for example, personal days off, other projects being due, travel, etc.,) making the challenge of determining a harmonious schedule difficult for the group, much less one person.

Embodiments of the subject technology remove the responsibility from any one person to determine a schedule. Technology is used to recommend a schedule in real-time and modifies the schedule as new information arrives. Embodiments use artificial intelligence to detect words that are related to scheduling topics. An RPA agent may “listen” as individuals speak, type, message, or provide other forms of communication that can be identified as word data related. The A.I. processes the word data in real-time as a meeting session is occurring. The A.I. engine determines recommended schedules that optimally reconcile everyone's schedule by a deadline, or at least optimize the schedule (for example, using a schedule that includes the least number of conflicts possible). In some embodiments, a machine learning process may use weighted importance od detected information to enhance A.I.-assisted meeting scheduling. This may involve for example, prioritizing the schedules of key participants to ensure their attendance over other non-key participants. Scheduling conflicts between designated key participants may be minimized before minimizing the participation of non-key participants. The approach takes into account factors such as the roles and contributions of participants, historical attendance data, urgency of meeting topics, and individual preferences to optimize meeting rescheduling proposal. As a recommended schedule is determined, the RPA agent may display a visual representation of the schedule on end user interfaces so that participants can review and object or accept scheduling as proposed. Participants may actively, indirectly affect the schedule by discussing subject matter that the RPA agent recognizes. The A.I. engine may identify that the information affects one or more dates and adjusts the recommended schedule in real-time. In some embodiments, new information may occur after a live meeting session that affects the proposed schedule. For example, in some embodiments, the RPA agent may continuously run in the background of a local computing device, detecting events outside a previous meeting such as messages about the related project, changes in one's calendar, missed deadlines, another project meeting whose deadlines impact the previous project, etc. The “offline” data may be processed by the A.I. engine which may send through the RPA agent, a revised or modified recommended schedule.

As will be appreciated, while many of the elements in the subject technology are software-based, the processes involved provide an improvement to electronic scheduling using computing technology; namely by automating the discovery of scheduling related data and processing the data to generate recommended schedules that often involve several peoples' schedules. It should be further appreciated that aspects of the teachings herein are beyond the capability of processing manually in a reasonable time by a human mind since the number of date/deadline combinations available to formulate a schedule between multiple parties is often in the thousands and beyond. In addition, the detection features in the subject technology identify words and find correlations between words that affect a schedule indirectly that one trying to manually keep track of, may miss or may not understand in real-time how another schedule deadline is affected by the information. Accordingly, the embodiments herein provide technology that is both useful and an improvement over the state of the art in electronic scheduling.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one or more storage devices that may include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 includes an example of an environment for the execution of at least some of the computer code involved in performing the inventive methods, such as the improved collaborative scheduling code 200. The improved collaborative scheduling code 200 may include a collaborative scheduling recommendation engine 240 and a robotic process automation (RPA) agent 250 that cooperate to generate recommended schedules for the collaboration of multiple parties working together on a project or set of dependent tasks. The collaborative scheduling recommendation engine 240 may operate as a backend process that receives data from the RPA agent 250 that is actively listening to conversations amongst the collaborating parties. The collaborative scheduling recommendation engine 240 and/or RPA agent 250 may operate according to one or more of the methods disclosed in further detail below. In addition to collaborative scheduling code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and collaborative scheduling code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

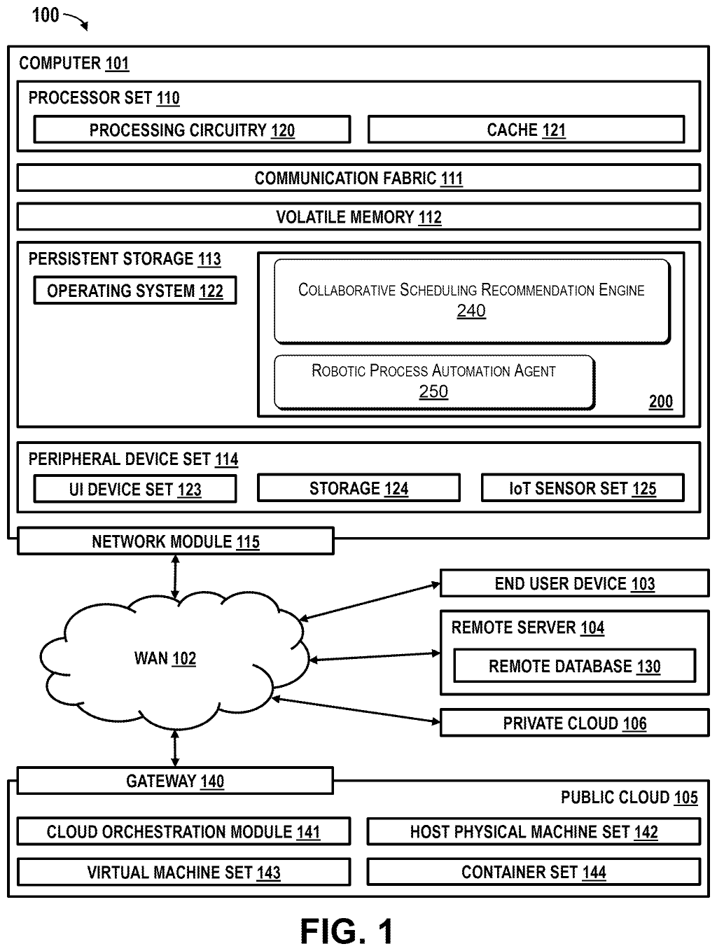

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. For the instant disclosure, the processor set 110 includes for example a central processing unit (CPU) and an accelerator. In some embodiments, a different type of processing element may be used instead of the CPU, (for example, a GPU or other process dedicated/specialized unit). Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in collaborative scheduling code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in collaborative scheduling code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

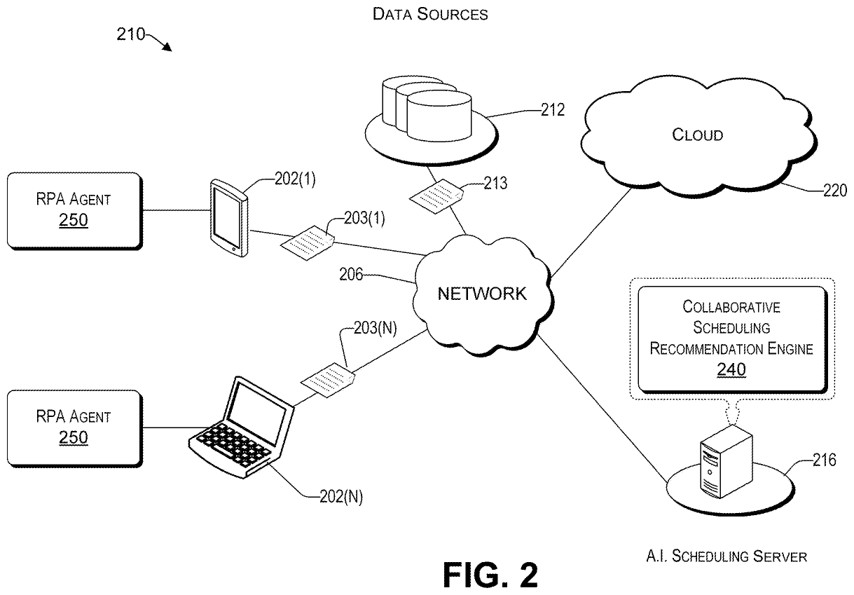

FIG. 2 illustrates an example architecture 210 for automated recommended scheduling of multiple parties using cognitive robotic process automation. Architecture 210 includes a network 206 that allows various computing devices 202 (1) to 202 (N) to communicate with each other, as well as other elements that are connected to the network 206, such as data source 212, an A.I. scheduling server 216, and the cloud 220. The computing devices 202 (1) to 202 (N) and A.I. scheduling server 216 may operate under the computing environment described above in FIG. 1. The A.I. scheduling server 216 may operate the collaborative scheduling code 200, including the collaborative scheduling recommendation engine 240. Embodiments may include the RPA agent 250, which will generally reside directly on computing devices 202, as either a downloaded program or as a plug-in that is added to one or more other programs such as a teleconferencing program and/or a calendar system (local or online). Generally, when a teleconference program starts a live session, the RPA agent 250 may initiate and communicate with the collaborative scheduling recommendation engine 240 through the network 206. In some embodiments, the RPA agent 250 is partially interactive (for example, in presenting recommended schedules) on respective end user interfaces, and includes an API for end users to provide feedback and other information through a user interface. The collaborative scheduling recommendation engine 240 may be configured to receive language data (verbal or printed) identified by the RPA agent 250, analyze the received data, and determine an optimized schedule of tasks for respective meeting participants based on the data received and data mined from respective computing devices 202.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows the collaborative scheduling recommendation engine 240, which is a software program running on A.I. scheduling server 216, to communicate with the data source 212, computing devices 202 (1) to 202 (N), and/or the cloud 220, to provide data processing. The data source 212 may include newly discovered data identified from statements made during a live meeting session, data identified from calendars or messages resident on respective computing devices 202, and historical data related to previous schedule related topics, proposed recommended schedules, users, accuracy of identified words related to schedules, etc., that will be processed under one or more techniques described here. In some embodiments, a data packet 213 may be received by the collaborative scheduling recommendation engine 240. This data packet 213 can be received by the collaborative scheduling recommendation engine 240 by either a push operation from the data source 212 or from a pull operation of the collaborative scheduling recommendation engine 240. In one embodiment, the data processing for the collaborative scheduling recommendation engine 240 is performed at least in part on the cloud 220.

For purposes of later discussion, several user devices appear in the drawing, to represent some examples of the computing devices that may be the source of data being analyzed depending on the task chosen. Aspects of the symbolic sequence data (e.g., 203 (1) and 203 (N)) may be communicated over the network 206 with the collaborative scheduling recommendation engine 240. Today, user devices typically take the form of desktop computers, portable handsets, smart-phones, tablet computers, personal digital assistants (PDAs), and smart watches, although they may be implemented in other form factors, including consumer, and business electronic devices. While the data source 212 and the collaborative scheduling recommendation engine 240 are illustrated by way of example to be on different platforms, it will be understood that in various embodiments, the data source 212 and the A.I. scheduling server 216 may be combined. In other embodiments, these computing platforms may be implemented by virtual computing devices in the form of virtual machines or software containers that are hosted in a cloud 220, thereby providing an elastic architecture for processing and storage.

### Example Methodology

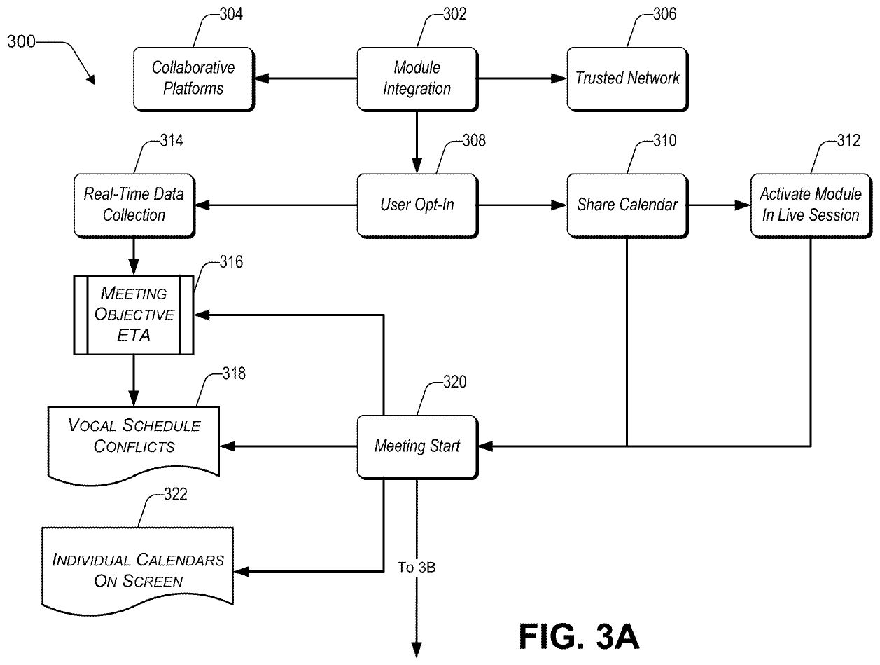

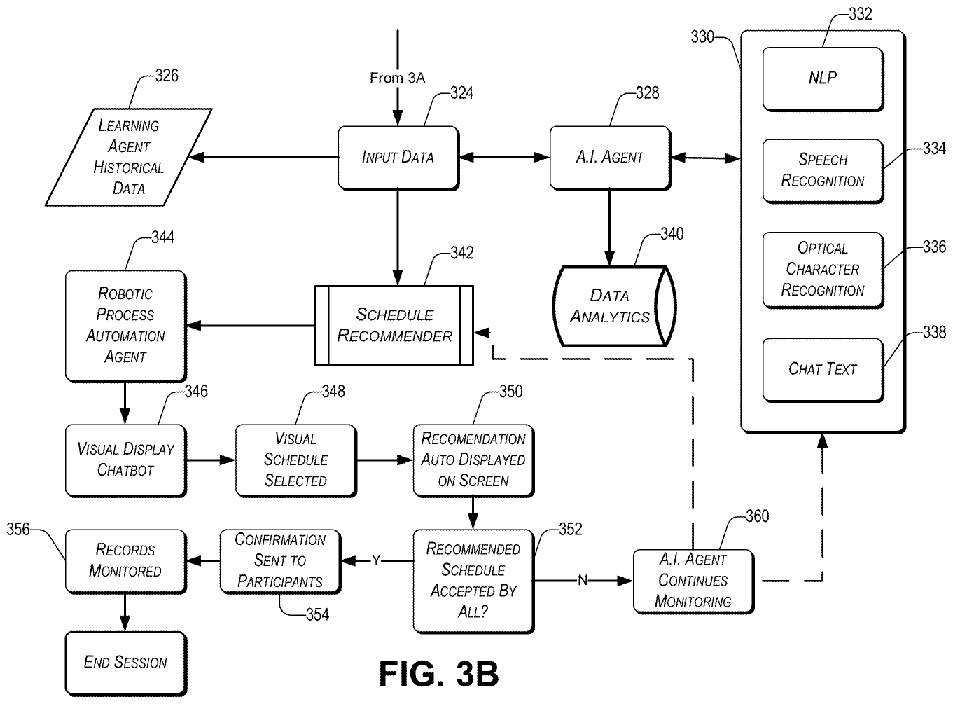

FIGS. 3A and 3B show a method 300 of electronic collaborative scheduling according to an illustrative embodiment. In some embodiments, the method 300 includes an initial integration 302 of a collaborative scheduling module (for example, a program such as an API that includes a combination of elements from the collaborative scheduling recommendation engine 240 and RPA agent 250) into a teleconferencing software host. In some embodiments, the RPA agent 250 may be a plug-in type module that runs independently and in a support role for the collaborative scheduling module by “listening” for schedule-related topics and providing display of recommended schedules for participants in a meeting. The RPA agent 250 may act as an addon/plug-in to existing collaborative tools that may be auto triggered to action when the RPA agent 250 detects conversational conflicts in schedules discussed. The RPA agent 250 may continue to listen in real-time and at the same time prepares to predict and optimize any re-scheduling recommendation while minimizing scheduling conflicts based on prioritizing of key participants to ensure their attendance. The collaborative scheduling module may run on one or more collaborative platforms 304 (for example, teleconferencing or other meeting software). In some embodiments, the data may be transmitted through trusted networks 306 (which may be analogous to network 206 in FIG. 2).

In some embodiments, users may be presented 308 with an opt-in option. Personal profile and related personalized user corpus data are authorized by the opt-in. Personal corpus history, preferences, and intent-based vocal data is collected, aggregated, and prepared for later filtering by the system. Encrypted analytics are saved in user profiles when using the features of the collaborative scheduling module. Users that opt-in may authorize the collaborative scheduling module to access their personal calendars. Individuals' calendars may be shared 310. The collaborative scheduling module may be activated 312 in a live electronic meeting session.

As the live session is active and a meeting starts 320 (or has started), the RPA agent 250 agent may collect 314 data in real-time. Real-time data collected includes speech that relates to scheduling (for example, deadlines, availability of individuals, milestone objectives, expected duration of tasks/projects, other meetings, recurring event calendar spacing, etc.). Speech may be spoken live between participants to one another (for example, as detected by microphones on respective computing devices or by an intercom device) or directly between a participant and a computing device. Printed text from individual computing devices may also be collected. For example, chat, notes, messaging, and the like may be collected for analysis. An example of non-verbal data collected includes for example, a printed meeting objective estimated time of arrival (completion) 316. The RPA agent 250 may identify the meeting topic intent from data objects in the meeting to prepare a possible workflow template recommendation.

The RPA agent may also detect vocalized scheduling conflicts 316 that participants discuss in the meeting. For example, one participant may announce they are on vacation or out of the office on certain dates (or generally that a date conflicts with their schedule). Another participant may announce they have another task or project pending on certain days. In some embodiments, the RPA agent 250 may examine 322 individual calendars on individual's screens. Data that is collected during the live meeting session (shown as “input data” 324)

may be forwarded 328 to an artificial intelligence (A.I.) engine (for example, the collaborative scheduling and recommendation engine 240) for data recognition and scheduling determination. The collaborative scheduling and recommendation engine 240 may include one or more word recognition technologies (for example, natural language processing (NLP) 332, speech recognition module 334, optical character recognition (OCR) module 336, chat text recognition module 338). Real-time voiced words, sentences and phrases are analyzed by one or more of the word recognition technologies. In some embodiments, the A.I. engine may determine scheduling intent behind the words that are expressed by participants. Time or schedule related speech may not be explicit. For example, during a conversation, someone may state “there will be an event next week that I may attend” that is spoken between the participants (i.e., not directly to the computing device). The collaborative scheduling and recommendation engine 240 may receive the statement and determine through machine learning that the statemen intends to express that the speaker's availability in the next week may be restricted by their attendance of an event (i.e., the schedule should reflect the speaker's availability as a negative value (or simply as unavailable) the next week). Analyzed data may be forwarded to a data analytics module 340. The data analytics module 340 may determine correlations between scheduled-based spoken/written data and commitments of individuals in the upcoming schedule.

Using the discovered data correlations, the collaborative scheduling and recommendation engine 240 may control a schedule recommendation module to determine 342 a recommended schedule. In generating the recommended schedule, the detected keywords related to schedules, times, and dates may be analyzed to determine a fit for individual's availability to complete tasks or projects. Counter responses from participants may be analyzed for follow-up responses. Correlations between previous dates and new dates from counter responses may be determined.

The generated recommended schedule may be forwarded 344 from the collaborative scheduling and recommendation engine 240 to the RPA agent 250. The RPA agent 250 may present 346 a display of the recommended schedule to meeting participants. For example, a link to an overall summary of the schedules and possible conflicts may be presented. In some embodiments, a data analysis driven prediction of the best schedule is shown as a graphic (for example, as a workflow, a decision tree, a process flow, a diagram etc.) on respective user interfaces. In some embodiments more than one possible schedule is generated and available. The RPA agent 250 may select 348 one of the schedules and display 350 the recommendation on the screen for meeting participants. In some embodiments, after participants have had a chance to review the recommended schedule, the participants may individually confirm 352 whether to accept or decline the schedule. If all participants accept the schedule, a confirmation message may be sent 354 to all participants. Records and conversation may be continuously monitored 356 for additional information (e.g., data) until the session ends. If one or more participants decline the recommended schedule, the collaborative scheduling and recommendation engine 240 may be sent a message to continue monitoring the session for data that can be used to generate a new proposed schedule. Additional conversations, messages, notes, etc. may be monitored and analyzed for generating a revised recommended schedule to present to the meeting participants until a schedule is agreed upon. In some embodiments, the final accepted schedule may still have conflicts present but generally tries to present an optimized schedule.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for electronic collaborative scheduling, the computer program product comprising:
one or more computer readable storage media, and program instructions collectively stored on the one or more computer readable storage media, the program instructions comprising:
operating a robotic process automation agent in a background of an electronic meeting;
receiving data related to schedule-based topics detected by the robotic process automation agent as coming from a plurality of participants in the electronic meeting;
forwarding the received data to an artificial intelligence engine;
determining, by the artificial intelligence engine, a recommended schedule of workflow completion for tasks related to topics of the electronic meeting; and
displaying, by the robotic process automation agent, the recommended schedule.

2. The computer program product of claim 1, wherein the program instructions further comprise:
continuously monitoring the electronic meeting for additional data related to schedule-based topics;
determining a revised recommended schedule based on the data related to schedule-based topics; and
updating the display using the revised recommended schedule.

3. The computer program product of claim 1, wherein the received data includes verbal speech, typed text, and individual personal calendars.

4. The computer program product of claim 1, wherein the artificial intelligence determines an intent to express speech related to schedule availability from one or more of the participants.

5. The computer program product of claim 1, wherein the program instructions further comprise determining an individual source associated with an instance of the received data.

6. The computer program product of claim 1, wherein the program instructions further comprise:
determining, by the artificial intelligence engine, one or more conflicts between individual participants' schedules;
optimizing the recommended schedule including the determined conflicts; and
displaying the recommended schedule including a display of one or more determined conflicts.

7. The computer program product of claim 1, wherein the program instructions further comprise:
displaying a confirmation of an acceptance of the recommended schedule to plurality of participants;
receiving a declination of acceptance by one or more of the plurality of participants;
continue monitoring the electronic meeting for additional data related to schedule-based topics;
determining a revised recommended schedule based on the data related to schedule-based topics; and
updating the display using the revised recommended schedule.

8. A computer implemented method for electronic collaborative scheduling, comprising:
operating a robotic process automation agent in a background of an electronic meeting;
receiving data related to schedule-based topics detected by the robotic process automation agent as coming from a plurality of participants in the electronic meeting;
forwarding the received data to an artificial intelligence engine;
determining, by the artificial intelligence engine, a recommended schedule of workflow completion for tasks related to topics of the electronic meeting; and
displaying, by the robotic process automation agent, the recommended schedule.

9. The method of claim 8, further comprising:
continuously monitoring the electronic meeting for additional data related to schedule-based topics;
determining a revised recommended schedule based on the data related to schedule-based topics; and
updating the display using the revised recommended schedule.

10. The method of claim 8, wherein the received data includes verbal speech, typed text, and individual personal calendars.

11. The method of claim 8, wherein the artificial intelligence engine determines an intent to express speech related to schedule availability from one or more of the participants.

12. The method of claim 8, further comprising determining an individual source associated with an instance of the received data.

13. The method of claim 8, further comprising:
determining, by the artificial intelligence engine, one or more conflicts between individual participants' schedules;
optimizing the recommended schedule including the determined conflicts; and
displaying the recommended schedule including a display of one or more determined conflicts.

14. The method of claim 8, further comprising:
displaying a confirmation of an acceptance of the recommended schedule to plurality of participants;
receiving a declination of acceptance by one or more of the plurality of participants;
continue monitoring the electronic meeting for additional data related to schedule-based topics;
determining a revised recommended schedule based on the data related to schedule-based topics; and
updating the display using the revised recommended schedule.

15. A computing device, comprising:
a processor operating a teleconferencing program and a robotic automation process agent running in a background of the teleconferencing program; and
a memory coupled to the processor, the memory storing instructions to cause the processor to perform acts comprising:
operating the robotic process automation agent in a background of an electronic meeting hosted by the teleconferencing program;
receiving data related to schedule-based topics detected by the robotic process automation agent as coming from a plurality of participants in the electronic meeting;
forwarding the received data to an artificial intelligence engine;
determining by the artificial intelligence engine, a recommended schedule of workflow completion for tasks related to topics of the electronic meeting; and
displaying, by the robotic process automation agent, the recommended schedule.

16. The computing device of claim 15, wherein the instructions cause the processor to perform further acts comprising:
continuously monitoring the electronic meeting for additional data related to schedule-based topics;
determining a revised recommended schedule based on the data related to schedule-based topics; and
updating the display using the revised recommended schedule.

17. The computing device of claim 15, wherein the artificial intelligence engine determines an intent to express speech related to schedule availability from one or more of the participants.

18. The computing device of claim 15, wherein the instructions cause the processor to perform further acts comprising determining an individual source associated with an instance of the received data.

19. The computing device of claim 15, wherein the instructions cause the processor to perform further acts comprising:
determining, by the artificial intelligence engine, one or more conflicts between individual participants' schedules;
optimizing the recommended schedule including the determined conflicts; and
displaying the recommended schedule including a display of one or more determined conflicts.

20. The computing device of claim 15, wherein the instructions cause the processor to perform further acts comprising:
displaying a confirmation of an acceptance of the recommended schedule to plurality of participants;
receiving a declination of acceptance by one or more of the plurality of participants;
continue monitoring the electronic meeting for additional data related to schedule-based topics;
determining a revised recommended schedule based on the data related to schedule-based topics; and
updating the display using the revised recommended schedule.
